(19) United States
(12) Patent Application Publication
(10) Pub. No.: US 2024/0220085 A1
(43) Pub. Date: Jul. 4, 2024

(54) METHOD FOR DISPLAYING PAGE SWITCHING AND RELATED DEVICE

(71) Applicant: TENCENT TECHNOLOGY (SHENZHEN) COMPANY LIMITED, Shenzhen (CN)

(72) Inventors: Biying HE, Shenzhen (CN); Yiying LU, Shenzhen (CN)

(21) Appl. No.: 18/607,544

(22) Filed: Mar. 18, 2024

Related U.S. Application Data
(63) Continuation of application No. PCT/CN2023/088671, filed on Apr. 17, 2023.

(30) Foreign Application Priority Data
Sep. 20, 2022 (CN) 202211146310.5

(51) Int. Cl. G06F 3/0483; H04L 51/04

(52) U.S. Cl. CPC G06F 3/0483; H04L 51/04

(57) ABSTRACT

This application discloses a method for displaying page switching and a related device. The method includes displaying a first communication interaction page of a messaging application, the first communication interaction page comprising at least one piece of communication interaction information, the communication interaction information corresponding to respective interaction types and at least one information level, and the information level corresponding to an interaction type of the communication interaction information; and switching the first communication interaction page to a second communication interaction page in response to a page switching operation on the first communication interaction page, an information level corresponding to the communication interaction information of each interaction type on the first communication interaction page being different from that on the second communication interaction page.

### RELATED APPLICATIONS

This application is a continuation of PCT Application No. PCT/CN2023/088671, filed on Apr. 17, 2023, which in turn claims priority to Chinese Patent Application No. 202211146310.5, filed with the China National Intellectual Property Administration on Sep. 20, 2022 and entitled “METHOD FOR DISPLAYING PAGE SWITCHING AND RELATED DEVICE.” The two applications are incorporated herein by reference in their entirety.

### FIELD OF THE TECHNOLOGY

This application relates to the field of computer technologies, and in particular, to a method for displaying page switching and a related device.

### BACKGROUND OF THE DISCLOSURE

With continuous development of Internet technologies, it becomes more common to interact with various types of messages by using a messaging application. For example, various types of messages such as a one-to-one chat, a group chat, and a subscription account are interacted by using the messaging application.

Often, various types of messages are usually presented on a chat list page. Accordingly, the organization of the messages is chaotic, and a device needs to respond to a complex operation to browse different types of messages. Further, the device needs to consume more device resources in response to the complex operation.

### SUMMARY

Embodiments of this application provide a method for displaying page switching and a related device. The related device may include a page switching display apparatus, an electronic device, a computer-readable storage medium, and a computer program product, thereby simplify user operation and saving device resources.

An embodiment of this application provides a method for displaying page switching. The method includes displaying a first communication interaction page of a messaging application, the first communication interaction page comprising at least one piece of communication interaction information, the communication interaction information corresponding to respective interaction types and at least one information level, and the information level corresponding to an interaction type of the communication interaction information; and switching the first communication interaction page to a second communication interaction page in response to a page switching operation on the first communication interaction page, an information level corresponding to the communication interaction information of each interaction type on the first communication interaction page being different from that on the second communication interaction page.

An embodiment of this application provides an electronic device, including a processor and a memory, the memory having a plurality of instructions stored therein, and the instructions being loaded by the processor, to perform operations in the method for displaying page switching according to the embodiments of this application.

An embodiment of this application further provides a non-transitory computer-readable storage medium, having a computer program stored thereon, and the computer program, when executed by a processor, performing operations in the method for displaying page switching according to the embodiments of this application.

In addition, an embodiment of this application further provides a computer program product, including a computer program or instructions, and the computer program or the instructions, when executed by a processor, performing operations in the method for displaying page switching according to the embodiments of this application.

An embodiment of this application provides a method for displaying page switching and a related device. This application may disperse communication interaction messages of different interaction types to different information levels, and may display communication interaction information at different information levels by switching displayed pages. This can make an organization of the communication interaction messages clear, thereby simplify user operation and saving device resources.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person skilled in the art may still derive other drawings from these accompanying drawings without creative efforts.

FIG. 1a is a schematic diagram of a scenario of a method for displaying page switching according to an embodiment of this application.

FIG. 1b is a flowchart of a method for displaying page switching according to an embodiment of this application.

FIG. 1c is a schematic diagram of a page of a method for displaying page switching according to an embodiment of this application.

FIG. 1d is a schematic diagram of another page of a method for displaying page switching according to an embodiment of this application.

FIG. 1e is a schematic diagram of still another page of a method for displaying page switching according to an embodiment of this application.

FIG. 1f is a schematic diagram of yet another page of a method for displaying page switching according to an embodiment of this application.

FIG. 1g is a schematic diagram of still yet another page of a method for displaying page switching according to an embodiment of this application.

FIG. 1h is another flowchart of a method for displaying page switching according to an embodiment of this application.

FIG. 1i is a schematic diagram of a method for displaying page switching according to an embodiment of this application.

FIG. 1j is another schematic diagram of a method for displaying page switching according to an embodiment of this application.

FIG. 2 is still another flowchart of a method for displaying page switching according to an embodiment of this application.

FIG. 3 is a schematic diagram of a structure of a page switching display apparatus according to an embodiment of this application.

FIG. 4 is a schematic diagram of an electronic device according to an embodiment of this application.

### DESCRIPTION OF EMBODIMENTS

The technical solutions in embodiments of this application are clearly and completely described below with reference to the accompanying drawings in the embodiments of this application. Apparently, the described embodiments are merely some rather than all of the embodiments of this application. All other embodiments obtained by a person skilled in the art based on the embodiments of this application without creative efforts shall fall within the protection scope of this application.

The embodiments of this application provide a method for displaying page switching and a related device. The related device may include a page switching display apparatus, an electronic device, a computer-readable storage medium, and a computer program product. The page switching display apparatus may be specifically integrated into an electronic device. The electronic device may be a device such as a terminal or a server.

It may be understood that the method for displaying page switching in this embodiment may be performed on the terminal, may be performed on the server, or may be jointly performed by the terminal and the server. The foregoing examples are not understood to be construed as limitations of this application.

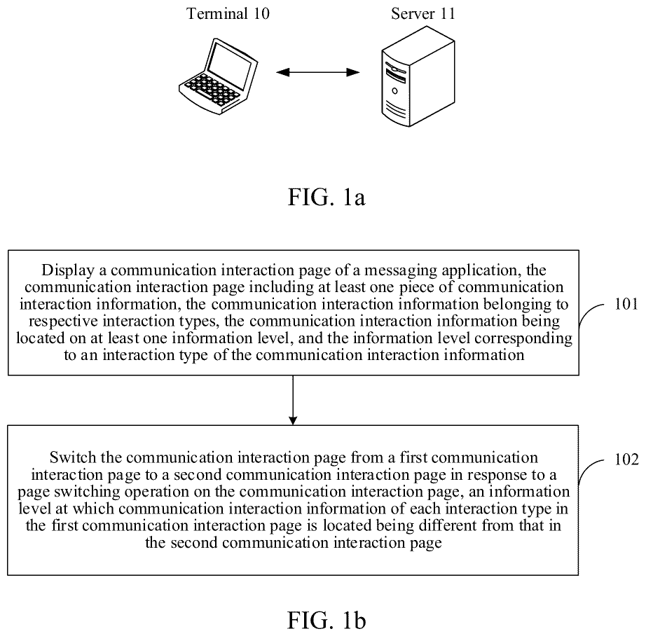

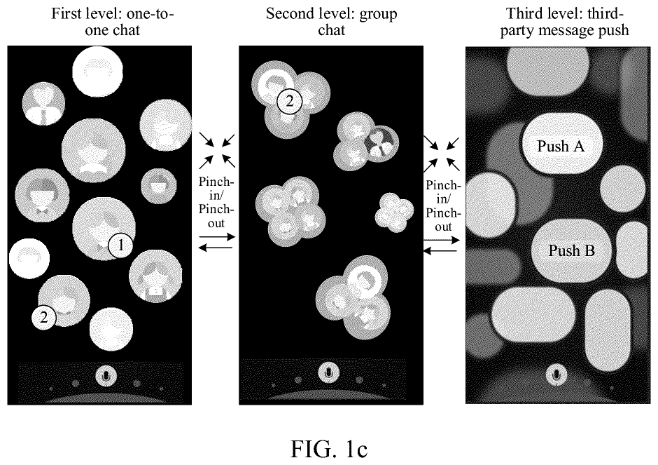

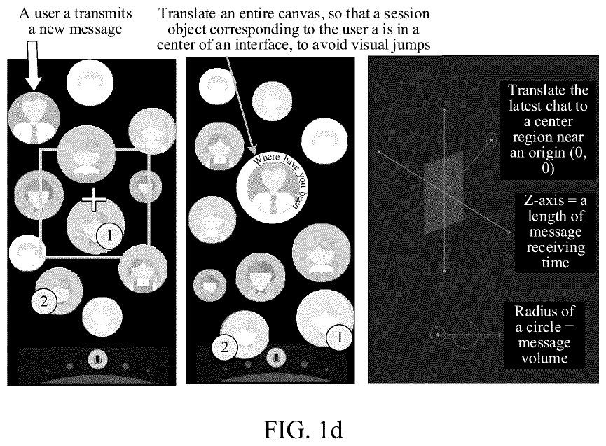

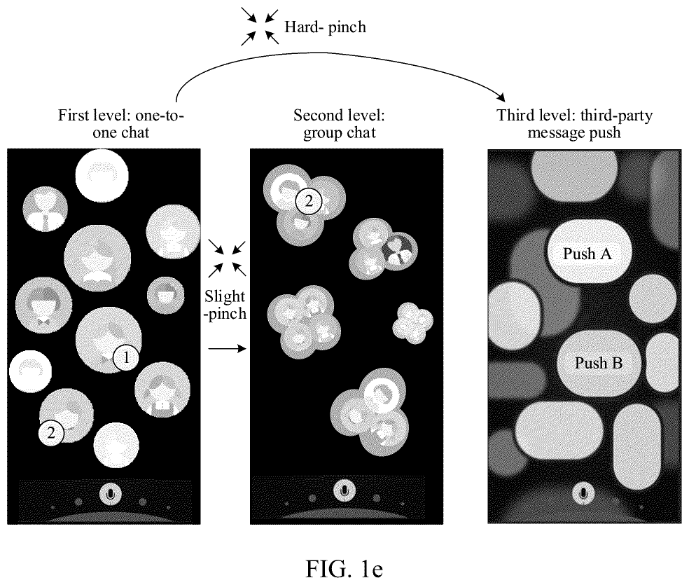

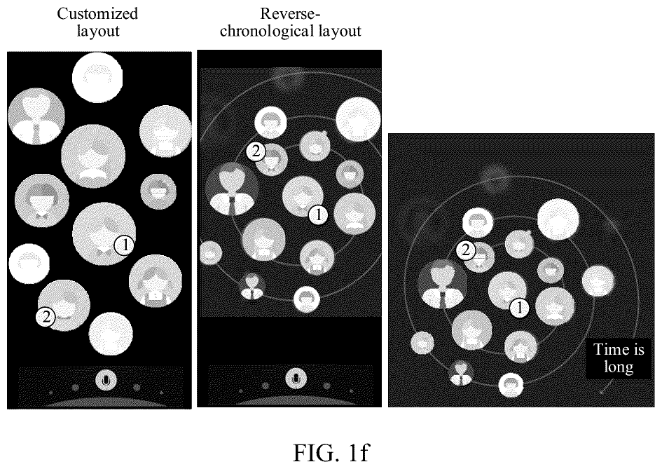

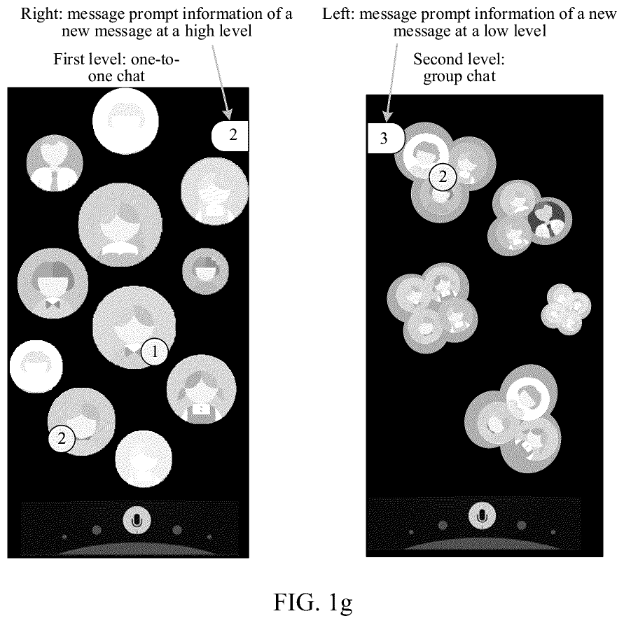

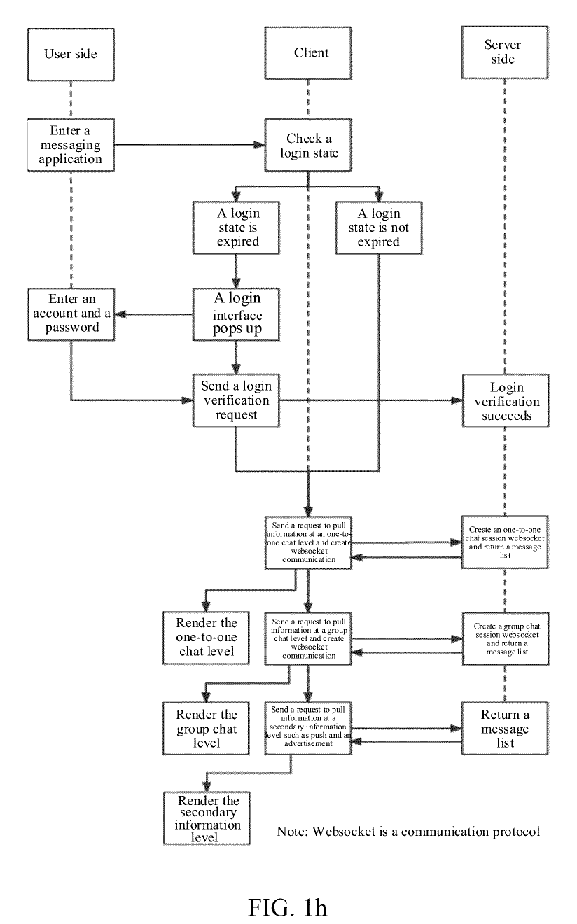

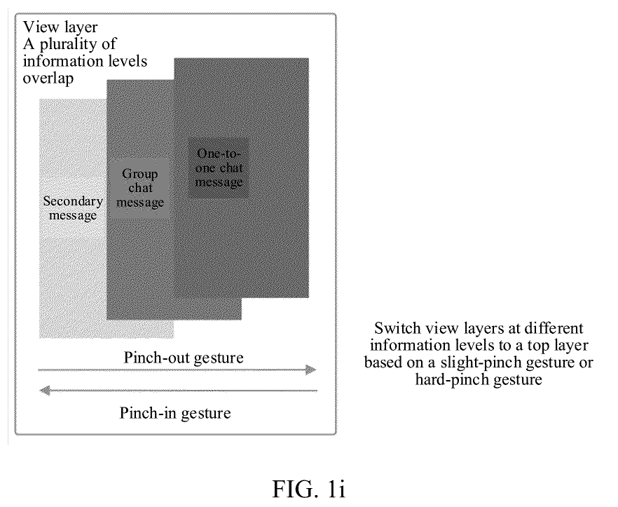

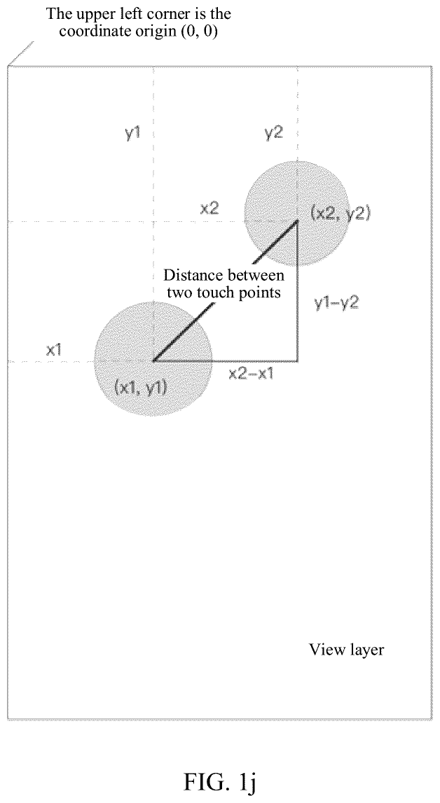

As shown in FIG. 1a, an example in which the terminal and the server jointly perform the method for displaying page switching is used. A page switching display apparatus provided in the embodiment of this application includes a terminal 10, a server 11, and the like. The terminal 10 is connected to the server 11 by using a network, for example, by using a wired or wireless network. The page switching display apparatus may be integrated into the terminal.

The terminal 10 may be configured to: display a communication interaction page of a messaging application, the communication interaction page including at least one piece of communication interaction information, the communication interaction information belonging to respective interaction types, the communication interaction information being located on at least one information level, and the information level corresponding to an interaction type of the communication interaction information; and switch the communication interaction page from a first communication interaction page to a second communication interaction page in response to a page switching operation on the communication interaction page, an information level at which communication interaction information of each interaction type in the first communication interaction page is located being different from that in the second communication interaction page. The terminal 10 may include a mobile phone, a smart television, a tablet computer, a notebook computer, a personal computer (PC), or the like. A client may be further provided on the terminal 10. The client may be an application client, a browser client, or the like.

The server 11 may be configured to: transmit a message for the messaging application to the terminal 10 to trigger the terminal 10 to hierarchically pull, in a case that a quantity of messages transmitted by the messaging application satisfying a preset quantity condition is detected, transmitted messages based on information levels corresponding to the transmitted messages; and display the communication interaction page based on the pulled messages at the information levels. The server 11 may be one server, or may alternatively be a server cluster or a cloud server including a plurality of servers. In the method for displaying page switching or apparatus disclosed in this application, a plurality of servers may form a blockchain, and the servers are nodes on the blockchain.

Detailed descriptions are separately provided below. Description orders of the following embodiments are not intended to limit preference orders of the embodiments.

This embodiment is described from a perspective of the page switching display apparatus. The page switching display apparatus may be specifically integrated into an electronic device. The electronic device may be a device such as a server or a terminal.

It may be understood that in the specific implementation of this application, relevant data such as user information is involved. In a case that the foregoing embodiments of this application are applied to a specific product or technology, a permission or consent of a user is required, and collection, use, and processing of the relevant data need to comply with relevant laws, regulations, and standards of relevant countries and regions.

This embodiment may be applied to various scenarios such as a cloud technology, artificial intelligence, intelligent transportation, and assisted driving.

As shown in FIG. 1b, a specific procedure of the method for displaying page switching may be as follows.

101: Display a communication interaction page of a messaging application, the communication interaction page including at least one piece of communication interaction information, the communication interaction information belonging to respective interaction types, the communication interaction information being located on at least one information level, and the information level corresponding to an interaction type of the communication interaction information.

The electronic device displays the communication interaction page of the messaging application. The messaging application may be a message interaction application, for example, may be specifically an instant messaging application, a social application, another application with an instant messaging function or a social function. This is not limited in this embodiment. The communication interaction page may be a page used for aggregating and displaying various communication interaction information in the messaging application. For example, the communication interaction page may be specifically a page used for aggregating and displaying various message sessions in the messaging application. Aggregating refers to gathering and display of the various message sessions. For example, the various message sessions may be aggregated and displayed in the form of a list, or the various message sessions may be aggregated and displayed in the form of a session cluster. The communication interaction information may be information in a communication interaction process, or may be description information of communication interactions. The description information is used for representing the information in the communication interaction process.

A message corresponding to the communication interactions here may refer to a communication interaction message that may be of many types. For example, the types of the communication interactions may specifically include a session type of the message session, or a service type corresponding to a service associated with the messaging application. The session type of the message session may further include a session type of one-to-one chat and a session type of group chat.

The information level corresponds to the interaction type of the communication interaction information. An information level may correspond to an interaction type of one communication interaction information. A quantity of information levels is determined based on a quantity of interaction types corresponding to the communication interaction information. The quantity of information levels may be the same as the quantity of the interaction types corresponding to the communication interaction information. For example, there are three information levels in a case that the quantity of interaction types corresponding to the communication interaction information is three. An information level included in the communication interaction page may be determined based on an interaction type of communication interaction information displayed in a communication interaction page. An interaction type of communication interaction information may be located at an information level. In this case, the quantity of interaction types of the communication interaction information in the communication interaction page is the same as the quantity of information levels. An information level is used for displaying an interaction type of communication interaction information. An order of the information level is determined based on an order of the interaction types corresponding to the communication interaction information displayed in the communication interaction page. Different information levels display communication interaction information of different interaction types. Different communication interaction pages correspond to different orders of interaction types. In other words, the different communication interaction pages correspond to different orders of the information levels. For example, an order of the interaction types corresponding to the communication interaction page may be a session type of one-to-one chat first, then a session type of group chat, and finally a service type. An information level of the communication interaction page has three layers. The first layer displays communication interaction information corresponding to the session type of one-to-one chat. The second layer displays communication interaction information corresponding to the session type of the group chat. The third layer displays communication interaction information corresponding to the service type. For example, another order of the interaction types corresponding to the communication interaction page may be a session type of group chat first, then a session type of one-to-one chat, and finally a service type. An information level of the communication interaction page has three layers. The first layer displays communication interaction information corresponding to the session type of the group chat. The second layer displays communication interaction information corresponding to the session type of one-to-one chat. The third layer displays communication interaction information corresponding to the service type. In an embodiment, the communication interaction page may alternatively only display communication interaction information corresponding to an information level. For example, a communication interaction page only displays the communication interaction information corresponding to the session type of one-to-one chat. An order of interaction types corresponding to each communication interaction page may be predetermined based on importance of corresponding communication interaction information, or may be set based on human needs. Each information level corresponds to a view layer. A view layer is used for displaying an interaction type of communication interaction information. A communication interaction page may have a plurality of view layers. Communication interaction information in a view layer with a high information level is displayed first in a case that communication interaction information displayed at different view layers in a communication interaction page overlaps.

Visibility of communication interaction information corresponding to different information levels in the communication interaction page is different. For example, communication interaction information at a first information level is completely visible, communication interaction information at a second information level is unclear, and communication interaction information at a third information level is completely invisible. Distances between the communication interaction information corresponding to different information levels in the communication interaction page and a center point of the page are different. A higher information level of the communication interaction information indicates a smaller distance from the center point of the page during displaying. A descending order of the information levels of the communication interaction information may be determined based on sizes of the levels. A smaller number of the information level indicates a higher information level. The communication interaction information corresponding to different information levels in the communication interaction page occupies different sizes of page regions during displaying. A higher information level indicates a larger page region occupied by the communication interaction information. A higher information level indicates higher importance of the communication interaction information displayed by the information level. All communication interaction information of corresponding interaction types is displayed in an information level of a communication interaction page. Communication interaction information of different interaction types is displayed in different information levels of the communication interaction page. Communication interaction information of the same interaction type is at the same information level. Communication interaction information of different interaction types in the same communication interaction page is located at different information levels. In this embodiment, the communication interaction information may be located at an information level in a session information architecture of the messaging application. The session information architecture may be an organization of a message. The session information architecture may include at least one information level, and each information level correspondingly displays a type of communication interaction information. Each information level in the session information architecture has a specific logical order. The logical order may be determined based on importance of communication interactions corresponding to the information levels, or the logical order may be set artificially. In some embodiments, importance of message content corresponding to different types of the communication interaction is different, and importance of corresponding communication interactions is determined based on the importance of the message content.

In a specific scenario, a session information architecture of a messaging application may include three information levels that may separately be an information level corresponding to a one-to-one chat (such as a one-to-one session), an information level corresponding to a group chat (a session group with at least two interaction objects), and an information level corresponding to third-party message push. The third-party message push here may specifically refer to message push of a service. The service may include forms, such as an official account, a subscription account, an advertisement, a broadcast, an applet. As shown in FIG. 1c, the information level corresponding to the one-to-one chat may be a first level by default. Description information of the one-to-one chat is displayed in the first level, and there are a plurality of one-to-one sessions. Description information of 11 one-to-one sessions is shown in the figure. The information level corresponding to the group chat may be a second level by default. Description information of the group chat is displayed in the second level, and there are a plurality of session groups with at least two interaction objects. Description information of 5 group chats is shown in the figure. The information level corresponding to the third-party message push may be a third level. Description information of pushed third-party messages is displayed in the third level, and there are also a plurality of third-party messages. The description information of the pushed messages shown in the figure includes push A and push B.

In this embodiment, colors of communication interaction information corresponding to the information levels are different. Colors of communication interaction information corresponding to different information levels are completely different. For example, a color of communication interaction information corresponding to an information level may be red, and a color of communication interaction information corresponding to another information level may be green.

Different colors here may alternatively refer to different transparency of colors.

Specifically, the information levels in the communication interaction page may be arranged in a preset order by default. A color of description information of communication interaction corresponding to an information level at the front of an arrangement position may be completely opaque. A color of description information of communication interaction corresponding to an information level at the back of the arrangement position is more transparent, or even completely transparent. It may be understood that if the color of the description information of the communication interaction in the information level at the back of the arrangement position is completely transparent, and only the color of the description information of the communication interaction in a target information level at the front of the arrangement position is completely opaque, only a target information level in the communication interaction page is visible. In other words, the target information level is highlighted in the communication interaction page.

The information level at the front of the arrangement position may be an information level at a top layer in the communication interaction page.

In this embodiment, the interaction types of the communication interaction information include a session type of a message session and a service type corresponding to a service associated with the messaging application, communication interaction information of the message session includes description information of a session member in the message session, and communication interaction information of the service includes content description information of message content published by the service.

The message session here may be a one-to-one chat (which may be regarded as a message session with two session members) or a multi-user group session. This is not limited in this embodiment.

The communication interaction information of the message session may include the description information of the session member in the message session, and the description information of the session member may include a nickname, a username, avatar information, and the like of the session member. The communication interaction information of the message session may further include a session name of the message session.

The service associated with the messaging application may specifically refer to a service provided by a service account subscribed by the messaging application. The service account here may be an official account or a personal account. This is not limited in this embodiment.

The content description information of the message content published by the service may be a part of the message content, such as some paragraphs of an article, or may be information such as a title, an abstract, or a publisher of the message content.

In this embodiment, communication interaction information of different services corresponds to different marker colors.

Specifically, as shown in FIG. 1c, if the push A is published by a service account 1, and the push B is published by a service account 2, in other words, a communication interaction corresponding to the push A is a communication interaction of a service provided by the service account 1, and a communication interaction corresponding to the push B is a communication interaction of a service provided by the service account 2, a message region for displaying communication interaction information corresponding to the push A may be marked in yellow, and a message region for displaying communication interaction information corresponding to the push B may be marked in green. The message region may be used for displaying content description information corresponding to the pushed content.

An electronic device may display message content corresponding to a service by using a triggering operation on communication interaction information of the service (such as a tap operation). The message content here may be content provided by the service, and a type of the content is not limited, for example, may be an article, a video, music, commodity information, or an advertisement.

In this embodiment, the interaction type of the communication interaction information includes a session type corresponding to a message session, the first communication interaction page includes at least one session object, and the session object includes description information of the message session.

The first communication interaction page may be specifically a currently displayed communication interaction page.

Specifically, refer to FIG. 1c. For an information level of a one-to-one chat, a session object may include an avatar of a chat object. For an information level of a group chat, a session object may be an identifier of the group chat that may specifically include avatars of session members in the group chat. For an information level of third-party message push, a session object corresponds to an official account or an applet, or the like, which may be used for displaying content description information corresponding to pushed content. In an embodiment, the second communication interaction page may include at least one session object, and the session object may also include description information of a message session. An information level at which communication interaction information of each interaction type in the first communication interaction page is located is different from that in the second communication interaction page.

In this embodiment, the method for displaying page switching may further include:
displaying, in response to a triggering operation on a target session object in the first communication interaction page, a session page of the target session object, the session page including message content transmitted by a session member in a message session corresponding to the target session object.

The triggering operation on the target session object may be specifically a tap operation, a sliding operation, a voice operation, another gesture operation, or the like on the target session object. This is not limited in this embodiment. The target session object may be any session object among session objects of the first communication interaction page.

The session page may be used for displaying a message transmitted by a session member of the target session object. A type of the message is not limited, for example, may be a video, an audio, an image, an expression, and a text. The message session corresponding to the target session object may specifically include at least one session member. In an embodiment, the electronic device may display, in response to a triggering operation on a target session object in the first communication interaction page, a session page of the target session object. The session page includes message content transmitted by a session member in a message session corresponding to the target session object. There may be at least two communication interaction pages, for example, may be the first communication interaction page and the second communication interaction page. Communication interactions corresponding to different communication interaction pages are at different information levels.

In this embodiment, the communication interaction information of the message session includes an avatar of a session member in the message session, and the session object is displayed around the avatar of the session member and is displayed by surrounding the avatar of the session member in a circular manner.

Session objects are displayed around each other. In other words, avatars of session members are displayed around each other.

In this embodiment, an arrangement of the session object in the first communication interaction page is determined by message receiving time of a message session corresponding to the session object.

The message receiving time here may specifically refer to receiving time of the latest message corresponding to the message session.

In a specific embodiment, a session object corresponding to a message session that has a shorter message receiving time to current time indicates a smaller distance of a target position in the first communication interaction page. On the contrary, a session object corresponding to a message session that has a longer message receiving time to current time indicates a greater distance of a target position in the first communication interaction page. The target position may be set according to an actual situation. For example, the target position may be a center in the first communication interaction page. For example, refer to the first page in FIG. 1d, the target position may be a position marked with “+” in a block in the page. In an embodiment, an arrangement of the session object in the communication interaction page is determined by message receiving time of a message session corresponding to the session object. There may be at least two communication interaction pages, for example, may be the first communication interaction page and the second communication interaction page. Communication interactions corresponding to different communication interaction pages are at different information levels.

In this embodiment, a display area of a session object in the first communication interaction page is determined based on message volume of message content corresponding to the session object.

The display area of the session object may be a size of a display region of the session object in the first communication interaction page. If the session object is presented in a circle, the display area of the session object may be calculated using a radius of a circle.

The message volume of the message content may specifically refer to a total quantity of messages transmitted, within a target time period, by a session member in the message session corresponding to the session object. The target time period may be a time period before the current time. The message volume of the message content may alternatively refer to a size of storage space occupied by the message transmitted, within the target time period, by the session member in the message session corresponding to the session object. In an embodiment, a display area of the session object in the communication interaction page is determined based on message volume of message content corresponding to the session object. The communication interaction page may be the first communication interaction page, or may be the second communication interaction page.

Specifically, a greater message volume of the message content corresponding to the session object indicates a larger display area of the session object. On the contrary, a smaller message volume of the message content corresponding to the session object indicates a smaller display area of the session object. In other words, the message volume of the message content corresponding to the session object is positively correlated with the display area of the session object.

In this embodiment, the display area of the session object is determined by message content of the message session corresponding to the session object, and the display area of the session object gradually increases as the message content corresponding to the message session increases.

More message content of the message session corresponding to the session object indicates a larger display area of the session object. On the contrary, less message content of the message session corresponding to the session object indicates a smaller display area of the session object.

In this embodiment, definition of the session object is determined based on a distance between a position of the session object in the first communication interaction page and a target position in the first communication interaction page.

The target position may be set according to an actual situation. For example, the target position may be a center in the first communication interaction page. The position of the session object in the first communication interaction page may be a center of the display region of the session object in the first communication interaction page. The center may be a position of a diagonal intersection point of the page or region.

Specifically, in some embodiments, a smaller distance between the position of the session object in the first communication interaction page and the target position in the first communication interaction page indicates a higher definition of the session object. A greater distance between the position of the session object in the first communication interaction page and the target position in the first communication interaction page indicates a lower definition of the session object. In an embodiment, definition of the session object in the communication interaction page is determined based on a distance between a position of the session object in the communication interaction page and a target position in the communication interaction. The communication interaction page may be the first communication interaction page, or may be the second communication interaction page.

In this embodiment, the method for displaying page switching may further include:
rearranging each session object in the first communication interaction page in response to a target message received by the first communication interaction page, to enable a session object corresponding to the target message to be at a target position of the first communication interaction page.

The target message may be specifically a new message currently received by the messaging application, and an information level to which a communication interaction type corresponding to the target message belongs is an information level highlighted by the first communication interaction page. The target position may be set according to an actual situation. For example, the target position may be a center of the first communication interaction page. In an embodiment, the electronic device rearranges each session object in the second communication interaction page in response to a target message received by the second communication interaction page, to enable a session object corresponding to the target message to be at a target position of the second communication interaction page.

In this embodiment, the step “the rearranging each session object in the first communication interaction page in response to a target message received by the first communication interaction page” may include:
dispersedly moving a session object located around the target position of the first communication interaction page in at least one predetermined direction in response to the target message received by the first communication interaction page and that a message session corresponding to the target message does not include historical message content; and
displaying the session object corresponding to the target message at the target position.

That a message session corresponding to the target message does not include historical message content mentioned here may refer to that the message session corresponding to the target message does not include a corresponding session object in the first communication interaction page. The historical message content is message content transmitted, within a historical time period, by the session member in the message session.

At least one predetermined direction may be set according to an actual situation, for example, may be various directions starting from the target position such as an upward direction, a downward direction, a left direction, and a right direction.

In an embodiment, the electronic device dispersedly moves a session object located around the target position of the communication interaction page in at least one predetermined direction in response to the target message received by the communication interaction page and that a message session corresponding to the target message does not include historical message content; and displays the session object corresponding to the target message at the target position. The communication interaction page may be the first communication interaction page, or may be the second communication interaction page.

Specifically, in some embodiments, if the first communication interaction page receives the target message, and the message session corresponding to the target message includes historical message content, in other words, the message session corresponding to the target message includes a corresponding session object in the first communication interaction page, the session object corresponding to the target message may be moved to the target position. In an embodiment, during movement of the session object corresponding to the target message, specifically, relative positions of each two session objects in the first communication interaction page may be remained unchanged. In other words, the session object in the first communication interaction page is moved as a whole. Accordingly, visual jumps can be avoided. In this embodiment, the method for displaying page switching may further include:
displaying, in response to a target message received by the first communication interaction page, message preview content on a session object corresponding to the target message, the message preview content including message content of the target message; and
displaying, in a case that display duration of the message preview content reaches preset duration and the target message is in an unread state, message unread prompt information on the session object corresponding to the target message, the message unread prompt information including a quantity of unread messages.

The preset duration may be set according to an actual situation, for example, the preset duration may be 3 seconds, or the like. In addition, the message unread prompt information may alternatively be presented in another manner. For example, the message unread prompt information may include a special identifier, and the special identifier may be a pentagram, an exclamation mark, or the like.

For example, as shown in FIG. 1d, if the first communication interaction page currently receives a new target message, and the target message is a new message “Where have you been” transmitted by a user a, a session object corresponding to the user a may be moved to a target position of the first communication interaction page (which may be specifically a center). After being moved to the target position, message preview content “Where have you been” of the transmitted message may be displayed on the session object corresponding to the user a. The message preview content may be displayed around an avatar of the user a.

Specifically, after the new message transmitted by the user a is received, an entire canvas may be translated, so that the session object corresponding to the user a is in a center of an interface (that is, the target position). In other words, the latest chat is moved to a center region near an origin (0, 0). Accordingly, relative positions between two session objects remain unchanged, and visual jumps can be avoided, as shown in FIG. 1d. The center of the interface may be regarded as the origin (0, 0).

In an embodiment, the electronic device may further display, in response to a target message received by the communication interaction page, message preview content on a session object corresponding to the target message. Message unread prompt information is displayed, in a case that display duration of the message preview content reaches preset duration and the target message is in an unread state, on the session object corresponding to the target message. The communication interaction page may be the first communication interaction page, may be the second communication interaction page, or may be another communication interaction page.

In this embodiment, the method for displaying page switching may further include:
merging, in response to an object drag operation on at least two session objects, the at least two session objects to generate a new target session object in a case that a distance of the at least two session objects on the first communication interaction page satisfies a preset session group merging condition; and
displaying the new target session object in the first communication interaction page, session members of the new target session object including session members of the at least two session objects.

The object drag operation may be specifically a sliding operation. The preset session group merging condition may be set according to an actual situation, for example, may be set to: The distance between the at least two session objects on the first communication interaction page is smaller than a preset distance.

In the foregoing embodiment, the at least two session objects are merged to generate a new target session object, and the original at least two session objects still exist. The foregoing process of merging and generating the target session object is equivalent to creating a new chat group. In an embodiment, the foregoing process of merging and generating the target session object may further be applied to another communication interaction page. For example, a new chat group may also be created on the second communication interaction page. To be specific, the electronic device merges, in response to an object drag operation on at least two session objects in the second communication interaction page, the at least two session objects to generate a new target session object in a case that a distance between the at least two session objects on the second communication interaction page satisfies a preset session group merging condition. A new target session object is displayed in the second communication interaction page.

In this embodiment, the method for displaying page switching may further include:
displaying, in response to an object disbanding operation on a target session object in the first communication interaction page, the target session object in a to-be-determined disbanding state in the first communication interaction page; and
dispersing, in response to a disbanding confirmation operation on the target session object, the target session object into a session object corresponding to at least one target session member, the target session member being a session member in a message session corresponding to the target session object before disbanding.

The target session object may be any session object in the first communication interaction page. The object disbanding operation and the disbanding confirmation operation may be set according to an actual situation. For example, the object disbanding operation may be set to a two-finger outward pull operation, or the like, and the disbanding confirmation operation may be set to a releasing operation, or the like.

The foregoing disbanding operation may be regarded as disbanding a chat group. In an embodiment, the foregoing method of disbanding the chat group may alternatively be applied to another communication interaction page. For example, the chat group may also be disbanded on the second communication interaction page To be specific, the electronic device displays, in response to an object disbanding operation on a target session object in the second communication interaction page, the target session object in a to-be-determined disbanding state in the second communication interaction page; and disperses, in response to a disbanding confirmation operation on the target session object, the target session object into a session object corresponding to at least two target session members. The target session member is a session member corresponding to the target session object before disbanding. The session member corresponding to the target session object refers to the session member in the message session corresponding to the target session object.

In this embodiment, the first communication interaction page further includes a message content input region, and the method for displaying page switching may further include:
obtaining, in response to a triggering operation on the message content input region, message content inputted by a user; and
transmitting, in response to a selection operation on a target session object in the first communication interaction page, the message content to a session member in a message session corresponding to the target session object.

The triggering operation on the message content input region may be a tap operation on the message content input region. This is not limited in this embodiment. The message content inputted by the user may be of various types such as a text, an audio, an image, and a video.

The selection operation on the target session object may be specifically a tap operation on the target session object, and the like. In an embodiment, another communication interaction page may also include a message content input region, so that the user may input message content in another communication interaction page by using the message content input region, and after the target session object is selected, the user may transmit the message content to a session member corresponding to a target session object.

In this embodiment, the message content input region includes at least one type of message input control, and each type of message input control is configured to input a corresponding type of message content, and
the step “the obtaining, in response to a triggering operation on message content input region, message content inputted by a user” may include:
determining a message input control of a selected target type in response to a selection operation on a message input control in the message content input region; and
obtaining, in response to a message input operation on the message input control of the target type, message content of the target type inputted by the user.

Specifically, the message content input region may include a message input control for inputting various types of the message content such as a text, an audio, an image, and a video.

The selection operation on the message input control may be a sliding operation, and the like. This is not limited in this embodiment.

In some embodiments, the message input control may enter a selected state by moving the message input control to a preset position in the message content input region. As shown in FIG. 1c, the preset position may be a middle position below the communication interaction page. A voice button below the communication interaction page is the selected message input control for inputting an audio type of the message content, and a user may input to-be-transmitted message content by long pressing the voice button.

In this embodiment, the step “the displaying a communication interaction page of a messaging application” may include:
hierarchically pulling, in a case that a quantity of messages transmitted by the messaging application satisfying a preset quantity condition is detected, the transmitted messages based on information levels corresponding to the transmitted messages; and
displaying the communication interaction page based on the pulled messages at the information levels.

The preset quantity condition may be set according to an actual situation. For example, the preset quantity condition may be that a quantity of messages transmitted for the messaging application is greater than a preset quantity, and the preset quantity may be set to 50. This is not limited in this embodiment.

In a specific scenario, importance of messages at different information levels is different. A pull order of messages at different information levels may be determined based on importance of a message at an information level corresponding to the transmitted message, and then hierarchical pulling may be performed based on the pull order. Specifically, a message at an information level with high message importance may be first pulled, and then a message at an information level with low message importance is pulled.

Importance of a message corresponding to an information level may be set according to an actual situation. This is not limited in this embodiment. For example, importance of a message at an information level corresponding to a one-to-one chat may be set to be higher than importance of a message at an information level corresponding to a group chat, and importance of a message at an information level corresponding to third-party message push may be set to be higher than the importance of the message at the information level corresponding to the group chat.

102: Switch the communication interaction page from a first communication interaction page to a second communication interaction page in response to a page switching operation on the communication interaction page, an information level at which communication interaction information of each interaction type in the first communication interaction page is located being different from that in the second communication interaction page.

The same communication interaction information may be at different information levels in different communication interaction pages, and the same communication interaction information may be at the same information level in different communication interaction pages. Communication interaction information displayed in the first communication interaction page is the same as communication interaction information displayed in the second communication interaction page, and an interaction type corresponding to each piece of communication interaction information also remains unchanged. The first communication interaction page uses an information level different from an information level of the second communication interaction page to display communication interaction information. To be specific, orders of information levels corresponding to the first communication interaction page and the second communication interaction page are different. Interaction types of to-be-displayed communication interaction information at the information levels corresponding to the first communication interaction page and the second communication interaction page are the same. In other words, it may also be understood that there is an information level and content displayed in the information level changes, in a case that the communication interaction page changes. For example, switching from the first communication interaction page to the second communication interaction page may be a change in content displayed at the highest information level, to be specific, may be that communication interaction information displaying a first interaction type may be changed to communication interaction information displaying a second interaction type.

In an embodiment, only one information level in different communication interaction pages may display communication interaction information of different interaction types, and another information levels may display communication interaction information of the same interaction type, or may display the communication interaction information of the different interaction types. For example, interaction types of communication interaction information displayed at first information levels of different communication interaction pages may be different, and interaction types of communication interaction information displayed at another information level may be the same or different. For example, an information level of one communication interaction page has three layers. The first layer displays communication interaction information corresponding to a session type of a one-to-one chat. The second layer displays communication interaction information corresponding to a session type of a group chat. The third layer displays communication interaction information corresponding to a service type. Another information level of the communication interaction page also has three layers. The first layer displays communication interaction information corresponding to the session type of the group chat. The second layer displays communication interaction information corresponding to the session type of one-to-one chat. The third layer displays communication interaction information corresponding to the service type. Interaction types of the communication interaction information displayed on the first layer in the two communication interaction pages are different. Interaction types of the communication interaction information displayed on the second layer are different. Interaction types of the communication interaction information displayed on the third layer are the same, and are all communication interaction information corresponding to the service type. All communication interaction information displayed in the first communication interaction page is displayed in the second communication interaction page. In other words, communication interaction information displayed in different communication interaction pages is the same. A difference is that there is an information level. An interaction type corresponding to the communication interaction information displayed in the first communication interaction page is different from an interaction type corresponding to the communication interaction information displayed in the second communication interaction page. For example, communication interaction information of a first interaction type displayed at the highest level in the second page is different from communication interaction information of a second type displayed at the highest level in the first page.

The page switching operation on the communication interaction page may be specifically a tap operation, a pinch-in and pinch-out operation (which may be regarded as a sliding operation), or the like on the communication interaction page. This is not limited in this embodiment.

For example, in the first communication interaction page, an information level of a communication interaction of one-to-one chat type is a top layer, while in the second communication interaction page, an information level of a communication interaction of group chat type is the top layer.

In this embodiment, information levels in the communication interaction page are arranged in a preset order, and
the step “the switching the communication interaction page from a first communication interaction page to a second communication interaction page in response to a page switching operation on the communication interaction page” may include:
determining, in response to the page switching operation on the communication interaction page, operation attribute information corresponding to the page switching operation;
determining a quantity of currently to-be-jumped information levels based on the operation attribute information; and
switching the communication interaction page from the first communication interaction page to the second communication interaction page based on the quantity.

The operation attribute information of the page switching operation may be specifically a movement rate, a quantity of tap, a press force, or the like corresponding to the page switching operation. This is not limited in this embodiment, and details may be determined based on a type of the page switching operation. For example, if the type of the page switching operation is a sliding operation, the operation attribute information may be a sliding rate (or referred to as the movement rate). If the type of the page switching operation is a tap operation, the operation attribute information may be a quantity of consecutive tap. If the type of the page switching operation is a press operation, the operation attribute information may be the press force.

A quantity of to-be-jumped information levels corresponding to attribute values of different operation attribute information is different. For example, if the page switching operation is a sliding operation, a higher sliding rate indicates a greater quantity of to-be-jumped information levels.

For example, in a case that the sliding rate is not greater than a1, the quantity of to-be-jumped information levels is 1. In a case that the sliding rate is greater than a1 and less than a2, the quantity of to-be-jumped information levels is 2. In a case that the sliding rate is not less than a2, the quantity of to-be-jumped information levels is 3, and a1<a2. If the communication interaction page includes four information levels arranged in the preset order, and currently, a first type of communication interaction is at the first information level (that is, a top information level), a second type of communication interaction is at the second information level, a third type of communication interaction is at the third information level, and a fourth type of communication interaction is at the fourth information level, the quantity of to-be-jumped information levels is four in a case that a user performs a page switching operation at a sliding rate of s (s>a2). The fourth type of communication interaction currently at the fourth information level may be switched to the first information level for display. A jump process of another type of communication interaction is similar. Specifically, the second communication interaction page is switched for display. In the second communication interaction page, the fourth type of communication interaction is at the first information level, the third type of communication interaction is at the fourth information level, the second type of communication interaction is at the third information level, and the first type of communication interaction is at the second information level.

It may be understood that in some embodiments, jump processes of the foregoing information levels may be circular. For example, for the second type of communication interaction, if the quantity of to-be-jumped information levels is 3, and is at the second information level currently, the second type of communication interaction may be jumped from the second information level to the first information level, then to the fourth information level, and finally may be jumped from the fourth information level to the third information level for display.

In this embodiment, the first communication interaction page highlights communication interaction information corresponding to a target information level, the first communication interaction page includes a message prompt region, the message prompt region includes message prompt information corresponding to a message at a neighboring information level of the target information level, and a position of the message prompt region in the first communication interaction page is determined based on a relationship between the neighboring information level and the target information level.

Specifically, the relationship between the neighboring information level and the target information level may include a left neighboring relationship and a right neighboring relationship. For example, the target information level may be the top information level, and neighboring information levels of the target information level may be the second information level and the last information level. The message prompt region may be used for prompting the user that there is unread message content in the neighboring information level. Highlight refers to that a manner of displaying the communication interaction information corresponding to the target information level is clearly different from a manner of displaying the communication interaction information corresponding to another information level. For example, the communication interaction information corresponding to the target information level may be highlighted, and the communication interaction information corresponding to another information level may not be highlighted. For example, the communication interaction information corresponding to the target information level may be clearly displayed, and the communication interaction information corresponding to another information level may be unclearly displayed.

Specifically, the information levels in the first communication interaction page may be arranged in a preset order (which may be regarded as a circular arrangement). If a specific information level is a left neighboring information level of the target information level, a message prompt region of the first communication interaction page may be located on the left side of the first communication interaction page. If a specific information level is a right neighboring information level of the target information level in the session information architecture, a message prompt region of the first communication interaction page may be located on the right side of the first communication interaction page.

This application provides a new form of chat list that is different from a form of message list in current related art. As shown in FIG. 1c, a chat list may be visually presented in the form of a user avatar, or an avatar and a username. Users are distinguished by a unique user identification (UID). The UID may be viewed in detailed information of a user.

Refer to division of information levels in FIG. 1c. A first level is an information level corresponding to a one-to-one chat, and is used for processing chat messages between individuals. A second level is an information level corresponding to a group chat, and is used for processing multi-group chat messages. A third level is an information level corresponding to third-party message push, and may include but not limited to push, a reminder, a broadcast, an advertisement, and the like. It may be understood that an information level of this embodiment includes extensibility to satisfy a message push requirement belonging to a higher product logic level. The user may switch between neighboring information levels by a pinch-in/pinch-out gesture.

For the information level corresponding to the one-to-one chat, description information of a message session included in a session object may be an avatar of a chat object. For the information level corresponding to the group chat, description information of a message session included in a session object may be avatars of all session members or some session members in the group chat, or may be an identifier of the group chat.

In addition, a quantity of unread messages of the message session corresponding to the session object may further be displayed on the session object. As shown in FIG. 1c, some avatars in a communication interaction page corresponding to the one-to-one chat or the group chat are marked with numbers. If the number “1” is marked, it means that the quantity of unread messages in a message session corresponding to the session object is 1. If the number “2” is marked, it means that the quantity of unread messages in a message session corresponding to the session object is 2.

The communication interaction page may include a voice control. In this embodiment, voice information of the user may be acquired by a triggering operation on the voice control (such as a tap or long press operation). After the voice information is acquired, the voice information may be selected to be sent to a message session in the messaging application.

In a specific embodiment, refer to FIG. 1d. A process in which a canvas of the communication interaction page is adjusted in a case that a new message is received is shown. The session object in the information level corresponding to the one-to-one chat may be presented in a circle, and the session object includes an avatar of a chat object. A radius of the circle may represent message volume of a historical dialog between a current user and the chat object. A greater radius indicates greater message volume. It may be learned that in FIG. 1d, in this embodiment, a Z-axis representation of the chat object that represents a length of the message receiving time may further be introduced. A farther distance from an origin of the Z-axis indicates longer receiving time of the latest message in the message session from current time. Specifically, avatars in the communication interaction page have a long and short distance. A farther avatar indicates an apparent blur effect, and represents that the latest message occurs at a farther time point.

Specifically, if a specific contact has ever performed a chat interaction operation, in other words, a session object corresponding to the contact currently exists in a chat canvas, the latest message preview animation appears on an avatar of the corresponding session object first in a case that a new message “Where have you been” transmitted by the contact is received. The message preview animation includes message content “Where have you been”, and then is summarized as a numeral representation of message unread prompt information “1”. In addition, the entire canvas may alternatively be translated, so that the contact is in a center of the interface, to be specific, the latest chat is moved to a center region near an origin (0, 0). Accordingly, relative positions between two session objects remain unchanged, and visual jumps can be avoided, as shown in FIG. 1d. The center of the interface may be regarded as the origin (0, 0).

If the contact has never performed the chat interaction operation, in other words, the contact does not exist in the chat canvas, the avatar of the contact is drawn at the origin (0,0) of the canvas coordinate with a fixed radius in a case that a new message from the contact is received. The avatar originally located near the origin is spread out radially, and a spread distance is greater than a radius of an avatar of a newly created contact, and then a process of a message preview animation in the foregoing embodiment is repeated.

In this embodiment, rapid jumps between different information levels may be implemented, in a case that information levels are switched and jumped, based on a slight and hard gesture. Specifically, a zoom speed of fingers in the same time unit may be distinguished to distinguish a slight-pinch gesture and a hard-pinch gesture. Switching between neighboring levels is implemented in a case that the user pinches slightly. Spanned-level switching is implemented in a case that the user uses the hard-pinch gesture, as shown in FIG. 1e. The slight-pinch gesture and the hard-pinch gesture may further include extensibility that may define a subdivision level. For example, the highest-level gesture may jump up to 3 levels. This may include possibility of expanding to a higher level, such as considering a fourth level as a widget layer of an application.

The widget layer may include a component, a tool, a pendant, and the like, and may be specifically a widget formed by code executed on a web page based on hyper text markup language (HTML). A representation of the widget may be a video, news, a mini game, or the like. There are a plurality of manners to arrange session objects in the communication interaction page in this embodiment. A customized layout may be used, or a spiral-based reverse-chronological layout may be used. Specifically, refer to FIG. 1f. By default, sorting of the session objects uses the customized layout. The customized layout may be an organization in which an interface focus is always kept on a contact center of the latest message, and positions of two contacts are fixed. In addition, an additionally customized button, and the like may alternatively be supported. For example, it is supported that a spiral arrangement organization is adjusted based on the message receiving time in ascending order, or a conventional form message list may be used.

In this embodiment, a target position in the first communication interaction page may be used as a starting point, and the session objects may be arranged in a spiral arrangement organization on the first communication interaction page. The target position may be set according to an actual situation, for example, may be a center of the first communication interaction page.

In a specific embodiment, a message prompt function between different information levels may further be provided. As shown in FIG. 1g, a message prompt that conforms to level awareness is used. If each type of communication interaction is arranged in a preset order, such as a one-to-one chat, a group chat, and third-party message push, the arrangement may be a circular arrangement. A session information architecture includes three information levels, respectively are a first level, a second level, and a third level. If a current communication interaction of a one-to-one chat type is at the first level, a communication interaction of a group chat type is at the second level, and a communication interaction of the third-party message push is at the third level. Messages of the group chat and the third-party are to be prompted on the right. If a current communication interaction of a one-to-one chat type is at the third level, a communication interaction of a group chat type is at the first level, and a communication interaction of the third-party message push is at the second level. Messages of the group chat and the third-party are to be prompted on the left. If a current communication interaction of a one-to-one chat type is at the second level, a communication interaction of the third-party message push is at the first level, and a communication interaction of a group chat type is at the third level. Messages of the third-party and the group chat are to be prompted on the right and right, respectively. The message prompt information here may only be a set of a quantity of unread messages, or may also include extensibility of recent message content exposure. Specifically, the message prompt information may further include displaying an avatar of a contact who transmits the latest message or the latest message content.

Specifically, an information level higher than the current information level may be regarded as a high level, and message prompt information of a new message at the high level may be displayed on the right side of the current page. An information level lower than the current information level may be regarded as a low level, and message prompt information of a new message at the low level may be displayed on the left side of the current page.

For example, if there are two unread messages at the high level, the number “2” may be displayed on the right side of the current page. If there are three unread messages at the low level, the number “3” may be displayed on the left side of the current page, as shown in FIG. 1g.

In addition, this application may further provide a solution for creating a new chat. Specifically, a new chat session may be created by double-tap blank space in the chat canvas. A needed contact may be found, in a case that the new chat session is created, by searching an identity document (ID) of the chat session. During creating the new chat session, an ondblclick event of the canvas at the current information level may be detected. A callback function of the ondblclick event is called, in a case that the user double-tapping the blank space on the canvas being detected, to determine whether a currently tapped position includes a sub-element. If a sub-element list corresponding to a currently tapped position is empty, it means that a current double-tap point is blank space, a user selection interface is called, and an object to be chatted and interacted is selected in the user selection interface. Then, current user information and selected object information (such as an account representing identity information of the object) for chat and interaction are used as a request parameter to initiate a request to create a chat session to a server. The server verifies legitimacy of the user's identity based on the requested information. Legitimacy refers to the confirmation of the user's identity and the selection of a friend of the current user as the chat object. After legitimacy verification is completed, whether a chat session has been created may be searched in a database. If the chat session has been created, a unique mark corresponding to the chat session is obtained. If the chat session has not been created, a chat session is created and a corresponding unique mark is generated. Finally, the mark is returned to a client. The client searches for a chat session window corresponding to the mark. A new chat session window is created directly in a case that the chat session window is not found.

In a specific scenario, FIG. 1h is a main logic flowchart of message pulling and rendering in an information level. The detailed descriptions are as follows. After the user enters the messaging application, the client may check a login state of the messaging application. If the login state of the messaging application is expired, a login interface pops up, and the user enters an account and a password to send a login verification request. If login verification succeeds, the client sends a request to a server side to pull information at a one-to-one chat level by creating websocket communication, and the server side returns a message list of the one-to-one chat, thereby rendering the one-to-one chat level. Then, the client sends a request to the server side to pull information at a group chat level by creating the websocket communication, and the server side returns a message list of the group chat, thereby rendering the group chat level. Finally, the client sends a request to the server side to pull information at a secondary information level such as push and an advertisement, and the server side returns a corresponding message list, thereby rendering the secondary information level.

The websocket is a protocol for full-duplex communication over a single transmission control protocol (TCP) connection.

In an embodiment, the message list received by the client may be an array in a chronological order or reverse order. The chronological order or reverse order may be determined based on user settings. Each element in the list is a chat session object. The chat session object includes a plurality of session attributes of a message bubble (that is, the session object in the foregoing embodiment). The session attributes may include data, such as a bubble type (such as a one-to-one chat, a group chat), unique user identification information uid, avatar, and name. The array is obtained. A position of each message bubble may be rendered based on the following logic:
(1) Obtaining a center point (x1, y1) of a current view layer, rendering an extensible canvas, and a center point of the canvas coinciding with the center point of the view layer;
(2) using a position of a first element of the array, that is, a first message bubble, as the center point (x1, y1) of the canvas by default; and
(3) obtaining each element in the array accordingly, where a calculation process of a position of an n^{th} element (xn, yn) may refer to formula (1), formula (2), formula (3), and formula (4):

$$Rn = R ( n - 1 ) + m \qquad ( 1 )$$

$$angle = 30 \times n \qquad ( 2 )$$

$$xn = x 1 + Rn \times cos ( angle \times PI / 180 ) \qquad ( 3 )$$

$$yn = y 1 + Rn \times sin ( angle \times PI / 180 ) \qquad ( 4 )$$

Rn is a radius of a circle where the n^{th} element is located. R(n−1) is a radius of a circle where the (n−1)^{th} element is located. m is a fixed value. Therefore, a radius Rn of a circle where each element is located increases based on a radius R(n−1) of a circle where a previous element is located. angle is an angle of rotation each time a new element is rendered. PI is π. Accordingly, a position of each element may be calculated accordingly, and the position is constantly spiraling outward.

FIG. 1i is information level division of an overall framework of this solution. Specifically, view layers of information levels may overlap. For example, an information level corresponding to a one-to-one chat message, an information level corresponding to a group chat message, and an information level corresponding to a secondary message (that is, third-party message push) overlap. A user may perform switching between information levels by using a pinch-out gesture or pinch-in gesture. In this embodiment, view layers at different information levels may be switched, based on a slight gesture or hard gesture, to a top layer for display.

In this embodiment, as shown in FIG. 1j, an upper left corner is used as a coordinate origin (0, 0), and steps for implementing the pinch-in gesture and the pinch-out gesture may be as follows:
(1) Detecting a touch event: determining, in a case that a touch element on an interface is detected, whether a quantity of fingers on a screen is less than two;
(2) it indicating that a gesture start mark has been triggered if it is detected that the quantity of touching fingers is not less than two;
(3) obtaining coordinates of two touch points (startX1, startY1) and (startX2, start Y2);
(4) calculating an initial distance between the two touch points, where
a distance between the two touch points in a horizontal direction is: startX=startX2−startX1,
a distance between the two touch points in a vertical direction is: startY=startY1−start Y2, and
the distance (that is, a length of a hypotenuse) between two touch points is calculated by using the Pythagorean theorem: startDst=Math.sqrt (startX×startX+startY×start Y);
(5) detecting a touch movement event, and updating coordinates of the touch points;
(6) detecting a touch end event, determining whether there is a gesture start mark and the quantity of fingers on the interface is less than two, and resetting the mark if the gesture ends in a case that the quantity is less than two;
(7) obtaining coordinates of the last two touch points (endX1, endY1) and (endX2, endY2);
(8) calculating a distance between the two touch points at the end of the touch (similar to a diagram in (4)), where
a distance between the two touch points at the end of the touch in a horizontal direction is: endX=endX2−endX1,
a distance between the two touch points at the end of the touch in a vertical direction is: endY=endY1−endY2, and
the distance (that is, a length of a hypotenuse) between two touch points is calculated by using the Pythagorean theorem: endDst=Math.sqrt (endX×endX+endY×endY); and
(9) comparing sizes of startDst and endDst, determining a pinch-in gesture if startDst is greater, and determining a pinch-out gesture if startDst is smaller.

A process of determining a slight touch or hard touch is as follows:
(1) Detecting a touch event: determining, in a case that a touch element on an interface is detected, whether a quantity of fingers on a screen is less than two;
(2) recording, if it is detected that a quantity of touched fingers is not less than two, a current timestamp that is a timestamp t1 at starting of the touch;
(3) detecting a touch movement event, and recording the current timestamp t2; and
(4) calculating a time difference time=t2−t1, determining whether the time is greater than 1000 milliseconds, determining a hard touch if the time is greater than 1000 milliseconds, and determining a slight touch if the time is less than or equal to 1000 milliseconds.

An algorithm of determining a slight touch or hard touch is extensible and may capture the slight touch or hard touch and digitize the slight touch or hard touch, thereby implementing customized information level division, and implementing aggregation and classification of messages at different information levels.

In addition, extensibility of a subdivision level may be customized based on a slight gesture and hard gesture. Specifically, n information levels may be extended and defined based on different lengths of the time in the foregoing embodiment. Longer time indicates a more spanned information level. For example, there are n levels in total, and the current level is level 1. For example, during pinching-in using two fingers, the time difference time calculated by the foregoing embodiment is 1 s, then application switches to the page of level 2. If the calculated time difference is 2 s, application switches to the page of level 3, and so on.

In an instant messaging application, messages with different and descending push strengths as well as different requirements are usually concentrated on the same chat list page for sending and receiving. The organization and processing manner is chaotic and cannot implement efficient switching and screening of information. For example, in a common chat application, a one-to-one chat, a group chat, and third-party message push (such as an official account, a subscription account, a video account, collectively referred to as third-party messages) are message types with three descending message strength levels. Messages with three types of strengths are combined in the same interface for sending and receiving. This is coarse push of the message intensity.

However, the method for displaying page switching provided in this application clearly divides the granularity of the message strength, and may quickly switch between different information levels by using a pinch-in or pinch-out gesture, to be specific, switching between information levels corresponding to a one-to-one chat, a group chat, and third-party message. This can effectively distinguish chat levels and properly allocate user attention, thereby simplify user operation and saving device resources.

In addition, if new messages are pushed in the one-to-one chat, the group chat, the push, and the like, an existing solution needs to pull all of the new messages at the same time, so that a resource allocation is improper. This solution may be divided into a plurality of information levels based on message importance, and during initialization, messages may be pulled in granularity in a case that message volume exceeds a specific threshold. For example, no hierarchical pulling is performed in a case that a total quantity of messages (that is, a sum of one-to-one chats, group chats, and third-party messages)<n. The messages are pulled hierarchically in a case that the total quantity of messages>n, to implement a more proper resource allocation. Accordingly, message data is pulled in an order of importance. Compared with an original full pulling, this is faster in terms of user perception.

According to the foregoing descriptions, in this embodiment, a communication interaction page of a messaging application may be displayed. The communication interaction page includes at least one piece of communication interaction information, the communication interaction information belongs to respective interaction types, and the communication interaction information is located on at least one information level. Each information level corresponds to an interaction type of the communication interaction information. The communication interaction page is switched from a first communication interaction page to a second communication interaction page in response to a page switching operation on the communication interaction page. An information level at which communication interaction information of each interaction type in the first communication interaction page is located is different from that in the second communication interaction page. This application may disperse communication interaction messages of different types to different information levels, and may display communication interaction information at different information levels by page switching. This can make an organization of the communication interaction messages clear and can switch quickly, thereby simplify user operations and saving device resources.

According to the method described in the foregoing embodiment, the following further makes detailed descriptions by using an example in which a page switching display apparatus is specifically integrated in a terminal.

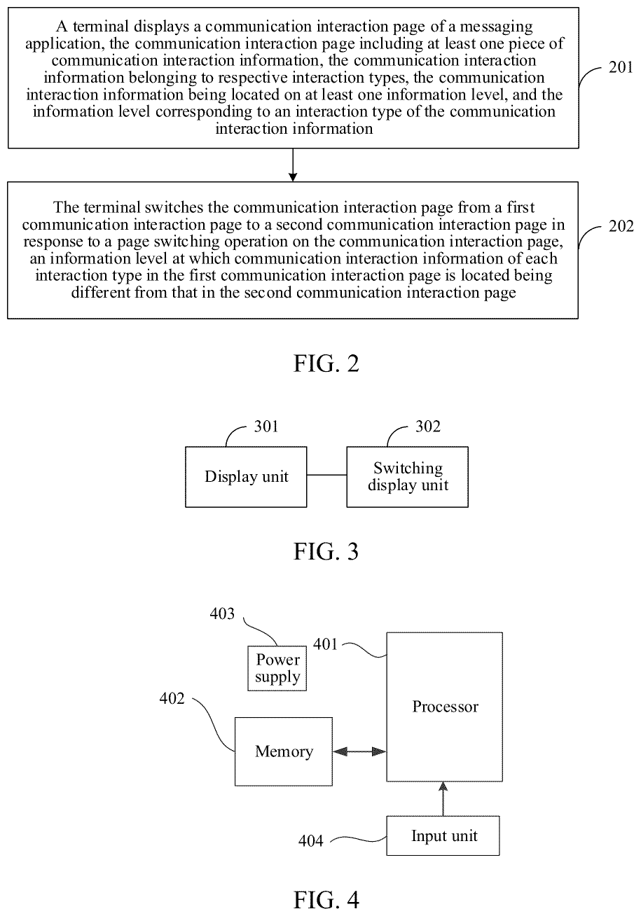

An embodiment of this application provides a method for displaying page switching. As shown in FIG. 2, a specific procedure of the method for displaying page switching may be as follows.

201: A terminal displays a communication interaction page of a messaging application, the communication interaction page including at least one piece of communication interaction information, the communication interaction information belonging to respective interaction types, the communication interaction information being located on at least one information level, and the information level corresponding to an interaction type of the communication interaction information.

In this embodiment, the communication interaction information may be located at an information level in a session information architecture of the messaging application. The session information architecture may be an organization of a message. The session information architecture may include at least one information level, and each information level correspondingly places an interaction type of communication interaction information. Each information level in the session information architecture has a specific logical order. In some embodiments, importance of message content corresponding to different types of communication interactions is different.

In this embodiment, colors of communication interaction information corresponding to the information levels are different.

Different colors here may specifically refer to different transparency of colors.

Specifically, the information levels in the communication interaction page may be arranged in a default order. A color of communication interaction information corresponding to an information level at the front of an arrangement position may be completely opaque. A color of communication interaction information corresponding to an information level at the back of the arrangement position is transparent, or even completely transparent. It may be understood that if the color of the communication interaction information in the information level at the back of the arrangement position is completely transparent, and only the color of the communication interaction information in the target information level at the front of the arrangement position is completely opaque, only a target information level in the communication interaction page is visible. In other words, the target information level is highlighted in the communication interaction page.

The information level at the front of the arrangement position may be an information level at a top layer in the communication interaction page.

In this embodiment, the interaction type of the communication interaction information includes a session type of a message session, the communication interaction information of the message session includes description information of a session member in the message session.

The message session here may be a one-to-one chat (which may be regarded as a message session with two session members) or a multi-user group session. This is not limited in this embodiment.

In this embodiment, the interaction types of the communication interaction information include a service type corresponding to a service associated with the messaging application, and description information of the service includes content description information of message content published by the service.

The service associated with the messaging application may specifically refer to a service provided by a service account subscribed by the messaging application. The service account here may be an official account or a personal account. This is not limited in this embodiment.

The content description information of the message content published by the service may be a part of the message content, or may be information such as a title, an abstract, or a publisher of the message content.

In this embodiment, description information of different services corresponds to different mark colors.

Message content corresponding to a service may be displayed by using a triggering operation on communication interaction information of the service (such as a tap operation). The message content here may be content provided by the service, and a type of the content is not limited, for example, may be an article, a video, music, commodity information, or an advertisement.

In this embodiment, a type of the communication interaction includes a session type corresponding to a message session, the first communication interaction page includes at least one session object, and the session object includes communication interaction information of the message session.

The first communication interaction page may be specifically a currently displayed communication interaction page.

Specifically, for an information level of a one-to-one chat, a session object may include an avatar of a chat object. For an information level of a group chat, a session object may be an identifier of the group chat that may specifically include avatars of session members in the group chat.

In this embodiment, the method for displaying page switching may further include:
displaying, in response to a triggering operation on a target session object in the first communication interaction page, a session page of the target session object, the session page including message content transmitted by a session member in a message session corresponding to the target session object.

The triggering operation on the target session object may be specifically a tap operation, a sliding operation, or the like on the target session object. This is not limited in this embodiment. The target session object may be any session object among session objects of the first communication interaction page.

The session page may be used for displaying a message transmitted by a session member of the target session object. A type of the message is not limited, for example be a video, an audio, an image, and a text. The message session corresponding to the target session object may specifically include at least one session member.

In this embodiment, an arrangement of the session object in the first communication interaction page is determined by message receiving time of a message session corresponding to the session object.

The message receiving time here may specifically refer to receiving time of the latest message corresponding to the message session.

In a specific embodiment, a session object corresponding to a message session that has a shorter message receiving time to current time indicates a smaller distance of a target position in the first communication interaction page. On the contrary, a session object corresponding to a message session that has a longer message receiving time to current time indicates a greater distance of a target position in the first communication interaction page. The target position may be set according to the actual situation. For example, the target position may be a center in the first communication interaction page.

In this embodiment, a display area of a session object in the first communication interaction page is determined based on message volume of message content corresponding to the session object.

The display area of the session object may be a size of the session object. If the session object is presented in a circle, the display area of the session object may be determined based on a radius of a circle.

The message volume of the message content may specifically refer to a total quantity of messages transmitted, within a target time period, by a session member in the message session corresponding to the session object.

In this embodiment, definition of the session object is determined based on a distance between the session object and a target position in the first communication interaction page.

The target position may be set according to an actual situation. For example, the target position may be a center in the first communication interaction page.

In this embodiment, the method for displaying page switching may further include:
rearranging each session object in the first communication interaction page in response to a target message received by the first communication interaction page, to enable a session object corresponding to the target message to be at a target position of the first communication interaction page.

The target message may be specifically a new message currently received by the messaging application, and an information level to which a communication interaction type corresponding to the target message belongs is an information level highlighted by the first communication interaction page. The target position may be set according to the actual situation. For example, the target position may be the center of the first communication interaction page.

Specifically, in some embodiments, if the first communication interaction page receives the target message, and the message session corresponding to the target message includes historical message content, in other words, the message session corresponding to the target message includes a corresponding session object in the first communication interaction page, the session object corresponding to the target message may be moved to the target position. In one embodiment, during movement of the session object corresponding to the target message, specifically, relative positions of each two session objects in the first communication interaction page may be remained unchanged. In other words, the session object in the first communication interaction page is moved as a whole. Accordingly, visual jumps can be avoided.

In this embodiment, the method for displaying page switching may further include:
displaying, in response to a target message received by the first communication interaction page, message preview content on a session object corresponding to the target message, the message preview content including message content of the target message; and
displaying, in a case that display duration of the message preview content reaches preset duration and the target message is in an unread state, message unread prompt information on the session object corresponding to the target message, the message unread prompt information including a quantity of unread messages.

The preset duration may be set according to an actual situation, for example, the preset duration may be 3 seconds, or the like. In addition, the message unread prompt information may alternatively be presented in another manner. For example, the message unread prompt information may include a special identifier, and the special identifier may be a pentagram, an exclamation mark, or the like.

In this embodiment, the step “the displaying a communication interaction page of a messaging application” may include:
hierarchically pulling, in a case that a quantity of messages transmitted by the messaging application satisfying a preset quantity condition is detected, the transmitted messages based on information levels corresponding to the transmitted messages; and
displaying the communication interaction page based on the pulled messages at the information levels.

The preset quantity condition may be set according to an actual situation. For example, the preset quantity condition may be that a quantity of messages transmitted for the messaging application is greater than a preset quantity, and the preset quantity may be set to 50. This is not limited to this embodiment.

In a specific scenario, the importance of messages at different information levels is different. A pull order of messages at different information levels may be determined based on importance of a message at an information level corresponding to the transmitted message, and then hierarchical pulling may be performed based on the pull order. Specifically, a message at an information level with high message importance may be first pulled, and then a message at an information level with low message importance is pulled.

202: The terminal switches the communication interaction page from a first communication interaction page to a second communication interaction page in response to a page switching operation on the communication interaction page, an information level at which communication interaction information of each interaction type in the first communication interaction page is located being different from that in the second communication interaction page.

In this embodiment, information levels in the communication interaction page are arranged in a preset order, and
the step “the switching the communication interaction page from a first communication interaction page to a second communication interaction page in response to a page switching operation on the communication interaction page” may include:
determining, in response to the page switching operation on the communication interaction page, operation attribute information corresponding to the page switching operation;
determining a quantity of currently to-be-jumped information levels based on the operation attribute information; and
switching the communication interaction page from the first communication interaction page to the second communication interaction page based on the quantity.

The operation attribute information of the page switching operation may be specifically a movement rate, a quantity of tap, a press force, or the like corresponding to the page switching operation. This is not limited to this embodiment, and details may be determined based on a type of the page switching operation. For example, if the type of the page switching operation is a sliding operation, the operation attribute information may be a sliding rate (or referred to as the movement rate). If the type of the page switching operation is a tap operation, the operation attribute information may be a quantity of consecutive tap. If the type of page switching operation is a press operation, the operation attribute information may be the press force.

The quantity of to-be-jumped information levels corresponding to attribute values of different operation attribute information is different. For example, if the page switching operation is a sliding operation, a higher sliding rate indicates a greater quantity of to-be-jumped information levels.

In this embodiment, the first communication interaction page highlights communication interaction information corresponding to a target information level, the first communication interaction page includes a message prompt region, the message prompt region includes message prompt information corresponding to a message at a neighboring information level of the target information level, and a position of the message prompt region in the first communication interaction page is determined based on a relationship between the neighboring information level and the target information level.

Specifically, the relationship between the neighboring information level and the target information level may include a left neighboring relationship and a right neighboring relationship. For example, the target information level may be the top information level, and neighboring information levels of the target information level may be the second information level and the last information level. The message prompt region may be used for prompting the user that there is unread message content in the neighboring information level.

Specifically, the information levels in the first communication interaction page may be arranged in a preset order (which may be regarded as a circular arrangement). If a specific information level is a left neighboring information level of the target information level, a message prompt region of the first communication interaction page may be located on the left side of the first communication interaction page. If a specific information level is a right neighboring information level of the target information level in the session information architecture, a message prompt region of the first communication interaction page may be located on the right side of the first communication interaction page.

According to the foregoing descriptions, in this embodiment, a communication interaction page of a messaging application may be displayed by using the terminal. The communication interaction page includes at least one piece of communication interaction information, the communication interaction information belongs to respective interaction types, and the communication interaction information is located on at least one information level. The information level corresponds to an interaction type of the communication interaction information. The communication interaction page is switched from a first communication interaction page to a second communication interaction page in response to a page switching operation on the communication interaction page. An information level at which communication interaction information of each interaction type in the first communication interaction page is located is different from that in the second communication interaction page. This application may disperse communication interaction messages of different types to different information levels, and may display communication interaction information at different information levels by page switching. This can make an organization of the communication interaction messages clear and can switch pages quickly, thereby simplify user operations and saving device resources.

To better implement the foregoing method, an embodiment of this application further provides a page switching display apparatus. As shown in FIG. 3, the page switching display apparatus may include a display unit 301 and a switching display unit 302.

### (1) Display Unit 301

The display unit is configured to display a communication interaction page of a messaging application. The communication interaction page includes at least one piece of communication interaction information, the communication interaction information belongs to respective interaction types, the communication interaction information is located on at least one information level, and the information level corresponds to an interaction type of the communication interaction information.

In some embodiments of this application, colors of communication interaction information corresponding to the information levels are different.

In some embodiments of this application, the interaction types of the communication interaction information include a session type of a message session and a service type corresponding to a service associated with the messaging application, communication interaction information of the message session includes description information of a session member in the message session, and communication interaction information of the service includes content description information of message content published by the service.

In some embodiments of this application, communication interaction information of different services corresponds to different marker colors.

In some embodiments of this application, the interaction type of the communication interaction information includes a session type corresponding to a message session, the first communication interaction page includes at least one session object, and the session object includes description information of the message session.

In some embodiments of this application, the page switching display apparatus may further include a session page display unit.

The session page display unit is configured to display, in response to a triggering operation on a target session object in the first communication interaction page, a session page of the target session object. The session page includes message content transmitted by a session member in a message session corresponding to the target session object.

In some embodiments of this application, the description information of the message session includes an avatar of a session member in the message session, and the session object is displayed around the avatar of the session member and is displayed by surrounding the avatar of the session member in a circular manner.

In some embodiments of this application, an arrangement of the session object in the first communication interaction page is determined by message receiving time of a message session corresponding to the session object.

In some embodiments of this application, a display area of the session object in the first communication interaction page is determined based on message volume of message content corresponding to the session object.

In some embodiments of this application, the display area of the session object is determined by message content of message session corresponding to the session object, and the display area of the session object gradually increases as the message content of the message session increases.

In some embodiments of this application, definition of the session object is determined based on a distance between the session object and a target position in the first communication interaction page.

In some embodiments of this application, the page switching display apparatus may further include an arrangement unit.

The arrangement unit is configured to rearrange each session object in the first communication interaction page in response to a target message received by the first communication interaction page, to enable a session object corresponding to the target message to be at a target position of the first communication interaction page.

In some embodiments of this application, the arrangement unit may include a moving subunit and a drawing display subunit.

The moving subunit is configured to dispersedly move a session object located around the target position of the first communication interaction page in at least one predetermined direction in response to the target message received by the first communication interaction page and that a message session corresponding to the target message does not include historical message content.

The drawing display subunit is configured to display the session object corresponding to the target message at the target position.

In some embodiments of this application, the page switching display apparatus may further include a preview unit and an unread prompt unit.

The preview unit is configured to display, in response to a target message received by the first communication interaction page, message preview content on a session object corresponding to the target message, and the message preview content includes message content of the target message.

The unread prompt unit is configured to display, in a case that display duration of the message preview content reaches preset duration and the target message is in an unread state, message unread prompt information on the session object corresponding to the target message, and the message unread prompt information includes a quantity of unread messages.

In some embodiments of this application, the page switching display apparatus may further include a session creation unit.

The session creation unit is configured to merge, in response to an object drag operation on at least two session objects, the at least two session objects to generate a new target session object in a case that a distance between the at least two session objects on the first communication interaction page satisfies a preset session group merging condition; and display the new target session object in the first communication interaction page, and session members of the new target session object include session members of the at least two session objects.

In some embodiments of this application, the page switching display apparatus may further include a session disbanding unit.

The session disbanding unit is configured to display, in response to an object disbanding operation on a target session object in the first communication interaction page, the target session object in a to-be-determined disbanding state in the first communication interaction page; and disperse, in response to a disbanding confirmation operation on the target session object, the target session object into a session object corresponding to at least one target session member, and the target session member is a session member in a message session corresponding to the target session object before disbanding.

In some embodiments of this application, the first communication interaction page further includes a message content input region, and the page switching display apparatus may further include a message input unit.

The message input unit is configured to obtain, in response to a triggering operation on message content input region, message content inputted by a user; and transmit, in response to a selection operation on a target session object in the first communication interaction page, the message content to a session member in a message session corresponding to the target session object.

In some embodiments of this application, the message content input region includes at least one type of message input control, and each type of message input control is configured to input a corresponding type of message content.

The step “the obtaining, in response to a triggering operation on message content input region, message content inputted by a user” may include:
determining a message input control of a selected target type in response to a selection operation on a message input control in the message content input region; and
obtaining, in response to a message input operation on the message input control of the target type, message content of the target type input by the user.

In some embodiments of this application, the display unit may include a pull subunit and a display subunit.

The pull subunit is configured to hierarchically pull, in a case that a quantity of messages transmitted by the messaging application satisfying a preset quantity condition is detected, the transmitted messages based on information levels corresponding to the transmitted messages.

The display subunit is configured to display the communication interaction page based on the pulled messages at the information levels.

### (2) Switching Display Unit 302

The switching display unit is configured to switch the communication interaction page from a first communication interaction page to a second communication interaction page in response to a page switching operation on the communication interaction page. An information level at which communication interaction information of each interaction type in the first communication interaction page is located being different from that in the second communication interaction page.

In some embodiments of this application, information levels in the communication interaction page are arranged in a preset order.

The switching display unit may include a first determining subunit, a second determining subunit, and a switching subunit.

The first determining subunit is configured to determine, in response to the page switching operation on the communication interaction page, operation attribute information corresponding to the page switching operation.

The second determining subunit is configured to determine a quantity of currently to-be-jumped information levels based on the operation attribute information.

The switching subunit is configured to switch the communication interaction page from the first communication interaction page to the second communication interaction page based on the quantity.

In some embodiments of this application, the first communication interaction page highlights communication interaction information corresponding to a target information level, the first communication interaction page includes a message prompt region, the message prompt region includes message prompt information corresponding to a message at a neighboring information level of the target information level, and a position of the message prompt region in the first communication interaction page is determined based on a relationship between the neighboring information level and the target information level.

According to the foregoing descriptions, in this embodiment, a communication interaction page of a messaging application may be displayed by using the display unit 301, the communication interaction page includes at least one piece of communication interaction information, the communication interaction information belongs to respective interaction types, the communication interaction information is located on at least one information level, and the information level corresponds to an interaction type of the communication interaction information. The communication interaction page is switched from a first communication interaction page to a second communication interaction page by the switching display unit 302 in response to a page switching operation on the communication interaction page, an information level at which communication interaction information of each interaction type in the first communication interaction page is located is different from that in the second communication interaction page. This application may disperse communication interaction messages of different types to different information levels, and may display communication interaction information at different information levels by page switching. This can make an organization of the communication interaction messages clear and can switch quickly, thereby simplify user operations and saving device resources.

An embodiment of this application further provides an electronic device. FIG. 4 is a schematic diagram of an electronic device in an embodiment of this application. The electronic device may be a terminal or a server.

Specifically, the electronic device may include components such as a processor 401 with one or more processing cores, a memory 402 with one or more computer-readable storage media, a power supply 403, and an input unit 404. A person skilled in the art may understand that the structure of the electronic device shown in FIG. 4 does not constitute a limit to the electronic device, and may include more or fewer parts than those shown in the figure, may combine some parts, or may have different part arrangements.

The processor 401 is a control center of the electronic device, and uses various interfaces and lines to connect all parts of the entire electronic device. Various functions of the electronic device are performed and data is processed, by running or executing a software program and/or a module that are/is stored in memory 402 and calling data stored in the memory 402. In an embodiment, the processor 401 may include one or more processing cores. In some embodiments, processor 401 may integrate an application processor and a modem. The application processor mainly processes an operating system, a user interface, an application, and the like. The modem mainly processes wireless communication. It may be understood that the foregoing modem processor may alternatively not be integrated into processor 401.

Memory 402 may be configured to store a software program and module. The processor 401 runs the software program and module stored in memory 402, to implement various functional applications and data processing. Memory 402 may mainly include a program storage region and a data storage region. The program storage region may store an operating system, an application required by at least one function (such as a sound playback function and an image display function), and the like. The data storage region may store data created according to use of the electronic device, and the like. In addition, the memory 402 may include a high-speed random access memory, and may also include a non-volatile memory, for example, at least one magnetic disk storage device, a flash memory, or another volatile solid-state storage device. Correspondingly, memory 402 may further include a memory controller, to provide access of the processor 401 to the memory 402.

The electronic device further includes the power supply 403 for supplying power to the components. In some embodiments, the power supply 403 may logically connect to the processor 401 by using a power supply management system, thereby implementing functions, such as charging, discharging, and power consumption management, by using the power supply management system. The power supply 403 may further include one or more of a direct current or alternating current power supply, a re-charging system, a power failure detection circuit, a power supply converter or an inverter, a power supply state indicator, and any other components.

The electronic device may further include the input unit 404. The input unit 404 may be configured to receive input information about number or character, and generate a keyboard, a mouse, a joystick, optical or trackball signal input related to user settings and function control.

Although not shown in the figure, the electronic device may further include a display unit, and the like. Details are not described herein again. Specifically, in this embodiment, the processor 401 in the electronic device loads, according to the following instructions, executable file corresponding to processes of one or more applications into the memory 402, and the processor 401 runs the application programs stored in the memory 402 to implement the following various functions:
displaying a communication interaction page of a messaging application, the communication interaction page including at least one piece of communication interaction information, the communication interaction information belonging to respective interaction types, the communication interaction information being located on at least one information level, and the information level corresponding to an interaction type of the communication interaction information; and switching the communication interaction page from a first communication interaction page to a second communication interaction page in response to a page switching operation on the communication interaction page, an information level at which communication interaction information of each interaction type in the first communication interaction page is located being different from that in the second communication interaction page.

For specific implementations of the foregoing operations, refer to the foregoing embodiments. Details are not described herein again.

According to the foregoing descriptions, in this embodiment, a communication interaction page of a messaging application may be displayed. The communication interaction page includes at least one piece of communication interaction information, the communication interaction information belongs to respective interaction types, and the communication interaction information is located on at least one information level. The information level corresponds to an interaction type of the communication interaction information. The communication interaction page is switched from a first communication interaction page to a second communication interaction page in response to a page switching operation on the communication interaction page. An information level at which communication interaction information of each interaction type in the first communication interaction page is located is different from that in the second communication interaction page. This application may disperse communication interaction messages of different interaction types to different information levels, and may display communication interaction information at different information levels by page switching. This can make an organization of the communication interaction messages clear and facilitate effective management of various types of communication interaction messages, thereby simplify user operations and saving device resources.

A person of ordinary skill in the art may understand that, all or some steps of the methods in the foregoing embodiments may be implemented by using instructions, or implemented through instructions controlling relevant hardware, and the instructions may be stored in a computer-readable storage medium and loaded and executed by a processor.

Accordingly, an embodiment of this application provides a computer-readable storage medium, having a plurality of instructions stored thereon. The instructions can be loaded by a processor, to perform operations in any method for displaying page switching according to the embodiments of this application. For example, the instructions may perform the following steps:
displaying a communication interaction page of a messaging application, the communication interaction page including at least one piece of communication interaction information, the communication interaction information belonging to respective interaction types, the communication interaction information being located on at least one information level, and the information level corresponding to an interaction type of the communication interaction information; and switching the communication interaction page from a first communication interaction page to a second communication interaction page in response to a page switching operation on the communication interaction page, an information level at which communication interaction information of each interaction type in the first communication interaction page is located being different from that in the second communication interaction page.

For specific implementations of the foregoing operations, refer to the foregoing embodiments. Details are not described herein again.

The computer-readable storage medium may include a read-only memory (ROM), a random access memory (RAM), a magnetic disk, an optical disc, or the like.

Since the instructions stored in the computer-readable storage medium may perform the operations of any method for displaying page switching in the embodiments of this application, the instructions can implement advantageous effects that may be implemented by any method for displaying page switching in the embodiments of this application. For details, refer to the foregoing embodiments. Details are not described herein again.

According to one aspect of this application, a computer program product or a computer program is provided. The computer program product or computer program includes computer instructions, and the computer instructions are stored in a computer-readable storage medium. The processor of the computer device reads the computer instructions from the computer-readable storage medium. The processor executes the computer instructions, so that the computer device performs the method provided in various implementations of the foregoing method for displaying page switching.

A method for displaying page switching and a related device according to embodiments of this application are described in detail above. The principles and implementations of this application are described herein by specific examples. The description about the embodiments above is merely provided for ease of understanding of the method and core ideas of this application. Meanwhile, a person of ordinary skill in the art can make variations to this application in terms of the specific implementations and application scopes according to the ideas of this application. Therefore, the content of the specification shall not be construed as a limit to this application.

What is claimed is:

1. A method for displaying page switching, performed by an electronic device, and comprising:
displaying a first communication interaction page of a messaging application, the first communication interaction page comprising at least one piece of communication interaction information, the communication interaction information corresponding to respective interaction types and at least one information level, and the information level corresponding to an interaction type of the communication interaction information; and
switching the first communication interaction page to a second communication interaction page in response to a page switching operation on the first communication interaction page, an information level corresponding to the communication interaction information of each interaction type on the first communication interaction page being different from that on the second communication interaction page.

2. The method according to claim 1, wherein communication interaction information corresponding to different information levels has different colors.

3. The method according to claim 1, wherein the interaction types of the communication interaction information comprise a session type of a message session and a service type corresponding to a service associated with the messaging application, communication interaction information of the message session comprises description information of a session member in the message session, and communication interaction information of the service comprises content description information of message content published by the service.

4. The method according to claim 3, wherein communication interaction information of different services corresponds to different colors.

5. The method according to claim 1, wherein the interaction type of the communication interaction information comprises a session type corresponding to a message session, the first communication interaction page comprises at least one session object, and the session object comprises description information of the message session.

6. The method according to claim 5, further comprising:
displaying a session page of a target session object in response to a triggering operation on the target session object in the first communication interaction page, the session page comprising message content transmitted by a session member in a message session corresponding to the target session object.

7. The method according to claim 5, wherein the description information of the message session comprises an avatar of a session member in the message session, and the session object is displayed around the avatar of the session member in a circular manner.

8. The method according to claim 5, wherein an arrangement of the session object in the first communication interaction page is determined by a message receiving time of a message session corresponding to the session object.

9. The method according to claim 5, wherein a display area of the session object in the first communication interaction page is determined based on message volume of message content corresponding to the session object.

10. The method according to claim 5, wherein a display area of the session object is determined by message content of a message session corresponding to the session object, and the display area of the session object increases as the message content corresponding to the message session increases.

11. The method according to claim 5, wherein definition of the session object is determined based on a distance between a position of the session object in the first communication interaction page and a target position in the first communication interaction page.

12. The method according to claim 5, further comprising:
rearranging each session object in the first communication interaction page in response to a target message received by the first communication interaction page, to enable a session object corresponding to the target message to be at a target position of the first communication interaction page.

13. The method according to claim 12, wherein the rearranging each session object in the first communication interaction page in response to a target message received by the first communication interaction page comprises:
moving a session object located around the target position of the first communication interaction page in at least one direction in response to the target message received by the first communication interaction page and that a message session corresponding to the target message does not comprise historical message content; and
displaying the session object corresponding to the target message at the target position.

14. The method according to claim 5, further comprising:
displaying, in response to a target message received by the first communication interaction page, message preview content on a session object corresponding to the target message, the message preview content comprising message content of the target message; and
displaying, in a case that display duration of the message preview content reaches preset duration and the target message is in an unread state, message unread prompt information on the session object corresponding to the target message, the message unread prompt information comprising a quantity of unread messages.

15. The method according to claim 5, further comprising:
merging, in response to an object drag operation on at least two session objects, the at least two session objects to generate a new target session object in a case that a distance of the at least two session objects on the first communication interaction page satisfies a preset session group merging condition; and
displaying the new target session object in the first communication interaction page, session members of the new target session object comprising session members of the at least two session objects.

16. The method according to claim 5, further comprising:
displaying, in response to an object disbanding operation on a target session object in the first communication interaction page, the target session object in a to be disbanding state in the first communication interaction page; and
dispersing, in response to a disbanding confirmation operation on the target session object, the target session object into a session object corresponding to at least one target session member, the target session member being a session member in a message session corresponding to the target session object before disbanding.

17. The method according to claim 5, wherein the first communication interaction page further comprises a message content input region, and the method further comprises:
obtaining message content in response to a triggering operation on the message content input region; and
transmitting, in response to a selection operation on a target session object in the first communication interaction page, the message content to a session member in a message session corresponding to the target session object.

18. The method according to claim 17, wherein the message content input region comprises at least one type of message input control, each type of message input control is configured to input a corresponding type of message content, and
the obtaining message content in response to a triggering operation on the message content input region, comprises:
determining a message input control of a selected target type in response to a selection operation on a message input control in the message content input region; and
obtaining message content of the target type in response to a message input operation on the message input control of the target type.

19. An electronic device, comprising a memory and a processor, the memory having an application stored therein, and the processor being configured to run the application in the memory to perform operations of a method for displaying page switching, comprising:
displaying a first communication interaction page of a messaging application, the first communication interaction page comprising at least one piece of communication interaction information, the communication interaction information corresponding to respective interaction types and at least one information level, and the information level corresponding to an interaction type of the communication interaction information; and
switching the first communication interaction page to a second communication interaction page in response to a page switching operation on the first communication interaction page, an information level corresponding to the communication interaction information of each interaction type on the first communication interaction page being different from that on the second communication interaction page.

20. A non-transitory computer-readable storage medium, the computer-readable storage medium having a plurality of instructions stored thereon, and the instructions being used for being loaded by a processor, to perform operations in a method for displaying page switching, comprising:
displaying a first communication interaction page of a messaging application, the first communication interaction page comprising at least one piece of communication interaction information, the communication interaction information corresponding to respective interaction types and at least one information level, and the information level corresponding to an interaction type of the communication interaction information; and
switching the first communication interaction page to a second communication interaction page in response to a page switching operation on the first communication interaction page, an information level corresponding to the communication interaction information of each interaction type on the first communication interaction page being different from that on the second communication interaction page.
